(19) United States
(12) Patent Application Publication
(10) Pub. No.: US 2023/0415671 A1
(43) Pub. Date: Dec. 28, 2023

(54) Interior Part for a Vehicle, Method for Producing Such an Interior Part, and Vehicle

(71) Applicant: Bayerische Motoren Werke Aktiengesellschaft, Muenchen (DE)

(72) Inventors: Thomas AUMANN, Buch am Erlbach (DE); Florian DECHANT, Adlkofen (DE); Johann GASSLHUBER, Buch am Erlbach (DE)

(21) Appl. No.: 18/339,813

(22) Filed: Jun. 22, 2023

(30) Foreign Application Priority Data
Jun. 24, 2022 (DE) 10 2022 115 728.8

(51) Int. Cl. B60R 13/02; D03D 1/00

(52) U.S. Cl. CPC B60R 13/02; D03D 1/00; D10B 2401/04; D10B 2505/12

(57) ABSTRACT

An interior part for a vehicle includes a decorative part composed of a textile material that has a fold section where the fold section is a portion of the textile material that has a changed material property. A method for producing an interior part for a vehicle includes providing a decorative part composed of a textile material and producing a fold section in the decorative part by changing a material property of the textile material along a line and/or in a region by an input of thermal energy.

### CROSS REFERENCE TO RELATED APPLICATION

This application claims priority under 35 U.S.C. § 119 from German Patent Application No. 10 2022 115 728.8, filed Jun. 24, 2022, the entire disclosure of which is herein expressly incorporated by reference.

### BACKGROUND AND SUMMARY

The invention relates to an interior part for a vehicle, having a decorative part composed of a textile material. The invention furthermore relates to a method for producing such an interior part and to a vehicle having such an interior part and/or having an interior part produced by way of such a method.

In vehicle construction, it is known to provide interior parts, such as for example instrument panels or central consoles, with an additional component that provides the interior part with an additional feature, such as for example a storage place. Owing to the restricted space conditions in the vehicle interior compartment, it is often not possible to accommodate elaborate additional components with an increased structural-space requirement or with awkward contours. Moreover, additional components increase the weight of the vehicle.

In order to give the vehicle interior compartment a high-quality appearance, it is known to provide interior parts with a decorative material which is adhesively bonded to a carrier part. As decorative material, use may be made of a wide variety of materials, such as for example real leather, artificial leather or a textile material.

DE 10 2016 101 765 A1 has disclosed a decorative material composed of textile that serves as a cover for an airbag of a motor vehicle. In one region, the decorative material has a weakening in the form of a predetermined breaking line, which is produced in that a substance is applied to the cover material and the substance changes the material property.

The present invention is based on the object of providing an interior part, a method for producing an interior part and a vehicle that are lightweight and inexpensive, have a flexible component surface and an appealing appearance and need a reduced structural-space requirement.

According to one aspect, an interior part for an interior compartment of a vehicle is provided. The interior part has a decorative part composed of a textile material that is provided with at least one fold section, wherein the fold section is produced in that, through input of energy, at least one material property of the textile material is changed.

Through the use of a decorative part composed of a textile material, the interior part has a low weight and an appealing appearance. Moreover, the fold section provides a component surface which is flexibly usable. In this regard, the interior part may serve for example as a cover in the retracted state and as stowage space in the expanded state. The fold section is produced through input of energy into the textile material and thus through targeted changing of the material properties. The targeted changing of the material properties allows the profile of the fold section to be specified in a defined manner.

Furthermore, as a result of its fold section, the interior part allows compact folding of the surface and consequently has a reduced structural-space requirement. Moreover, preliminary processes with regard to the manufacture of the component can be simplified or dispensed with. In this regard, production of a carrier part can be simplified and production processes, such as for example application of adhesive and lamination, or else complete components can be dispensed with. Consequently, a material saving is possible, which results in a low weight of the interior part.

The interior part may be a functional storage space or a concealing means, a cover or a screen for a storage compartment, a stowage compartment, a map case, a bottle holder, a storage compartment, a seat rear wall, a storage option, an instrument panel, a seat, a pillar, a sunshade, a steering-wheel cover, a headrest or a back-seat-area compartment.

The decorative part may also be referred to as decorative layer or optic layer. The decorative part may be a textile, a woven fabric, a warp-knitted fabric or a weft-knitted fabric. Preferably, the decorative part is a circular-knit material or a flat-knit material.

The textile material may be composed of textile raw materials, such as for example natural fibers or man-made fibers, such as for example thermoplastic fibers. Furthermore, the textile material may additionally comprise non-textile raw materials, such as for example leather or metal.

The fold section may also be referred to as bend section or bend/fold section. The fold section provides the interior part with a flexible component surface. The interior part may have multiple fold sections. For example, the interior part may be a corrugated bellows for a steering-wheel cover, so that, similar to an accordion effect, in the case of retraction and extension of the steering wheel, the steering-wheel cover is able to be provided individually in terms of its length as a result of the predetermined bending points. Alternatively, the interior part may be designed as an integrated drawer as a storage option in the interior compartment with accordion-type covering, a foldable map case, a bottle holder changeable in size, a storage compartment, a pocket, a flap or a bag or pouch for small parts.

The material property of the textile material may be a thickness, an elasticity, a density, a tensile strength or a tear resistance of the textile material. The input of energy may result in a multiple number of the aforementioned material properties being changed.

In an advantageous configuration, through the input of energy, the textile material is weakened and/or incipiently melted. In this way, the structure of the textile material is changed in a targeted manner in order to create a flexibly formed component surface.

In an advantageous configuration, the fold section extends along a line and/or in a region. In this way, the profile of the fold section and thus the function can be predefined in a targeted manner.

In an advantageous configuration, the input of energy is realized by means of a thermal process. A thermal process makes possible incipient melting of the textile material, in particular the fibers of the textile material, and consequently targeted weakening of the material in the composition of the material structure. The thermal process may be realized by means of lasers, warm air or a hot wire.

In an advantageous configuration, the decorative part composed of a textile material is a 2D knit material or a 3D knit material. In this way, a multiplicity of interior parts can be produced.

In an advantageous configuration, the interior part has a carrier part which is connected to the decorative part. In an advantageous configuration, the decorative part is connected in a materially bonded manner to the carrier part. The carrier part predefines the contour. The carrier part may be composed of plastic, such as for example polyurethane, or of a renewable raw material, such as for example wood. If the carrier part is composed of plastic, then the carrier part may be a plastic injection-molded part. Alternatively, the decorative part may be connected to the carrier part by means of a mechanical fastening. In this regard, through the input of energy, the decorative part may be changed in such a way that the decorative part forms fastening means which are mechanically connectable to the carrier part.

Advantageously, the decorative part is partially adhesively bonded to the carrier part. The adhesive bonding may be realized during the lamination process. For this purpose, an adhesive layer is partially applied to the decorative part and/or to the carrier part. In this regard, an adhesive layer may be applied to the edge of the decorative part and/or of the carrier part. Due to the property changes of the decorative part, the interior part is inherently rigid. Furthermore advantageously, an adhesive layer is applied over the full surface of the decorative part and/or of the carrier part. For the purpose of materially bonded connection, the adhesive layer can be activated in that it is heated and the decorative part is pressed onto the carrier part. Advantageously, the adhesive layer is composed of a thermoplastic adhesive. Furthermore advantageously, the adhesive layer may be a hot-melt adhesive.

According to a further aspect, a method for producing an interior part for a vehicle is provided. In the method, a decorative part composed of a textile material is provided. Afterwards, at least one fold section is produced in that, through input of energy, the textile material is changed along a line and/or in a region of the decorative part.

In an advantageous configuration, through input of energy, the textile material is incipiently melted and/or weakened. In this way, the structure of the textile material is changed in a targeted manner in order to create a flexibly formed component surface.

In an advantageous configuration, after a fold section has been produced, the decorative part is connected to a carrier part. For this purpose, the decorative part may be connected in a materially bonded manner to, in particular laminated onto, the carrier part.

According to a further aspect, a vehicle having at least one interior part according to the invention and/or having at least one interior part produced by way of a method according to the invention is provided.

A vehicle, an interior part, a method for producing an interior part and further features and advantages will be described in more detail below on the basis of an exemplary embodiment which is illustrated schematically in the figures.

### BRIEF DESCRIPTION OF THE DRAWINGS

FIG. 1 shows a vehicle;

FIG. 2 shows a cross section through an interior part according to a first embodiment;

FIG. 3 shows an enlarged detail of the interior part in FIG. 2;

FIG. 4 shows a schematic illustration of a method for producing the interior part; and

FIG. 5 shows an enlarged detail of a cross section through an interior part according to a second embodiment.

### DETAILED DESCRIPTION OF THE DRAWINGS

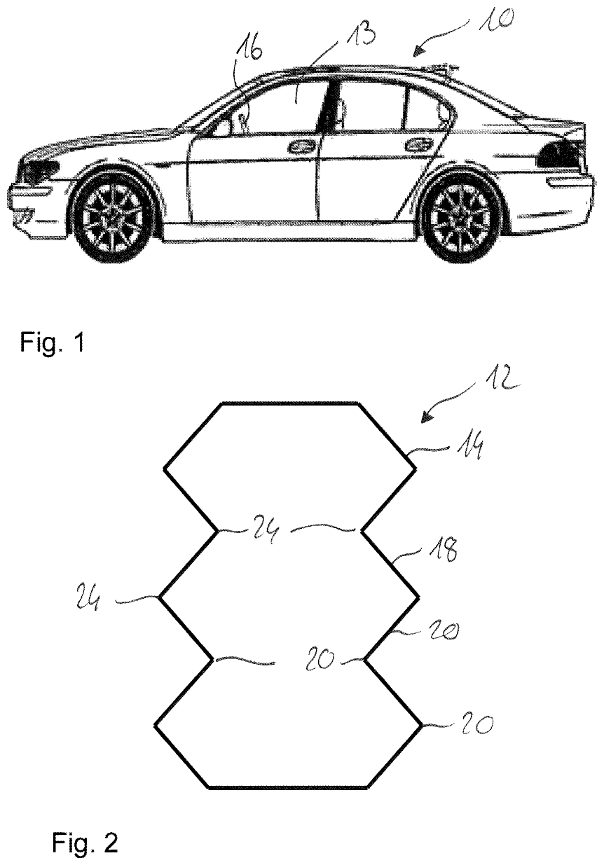

FIG. 1 shows a vehicle 10 which has an internal combustion engine (not illustrated) and/or an electric motor (not illustrated).

The vehicle 10 has an interior part 12 for an interior compartment 13 of the vehicle 10 that is illustrated in FIG. 2. The interior part 12 is a corrugated bellows 14 which serves as a steering-wheel cover for a steering wheel 16.

The interior part 12 has a decorative part 18 composed of a textile material. The decorative part 18 is a weft-knitted fabric 20, in particular a circular-knit material, composed of thermoplastic fibers. Alternatively, the decorative part 18 may be a flat-knit material. Instead of a weft-knitted fabric, the decorative part 18 may be textile, a woven fabric or a warp-knitted fabric.

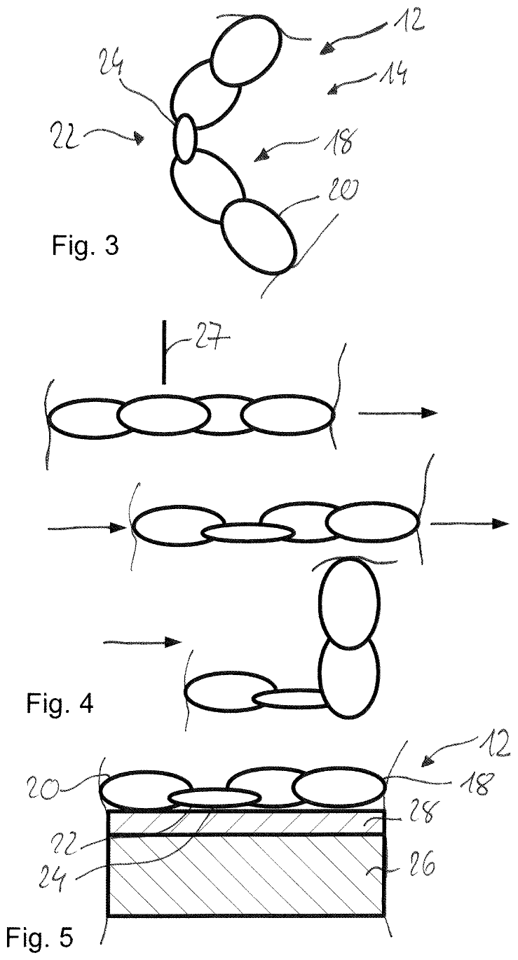

As can be seen by viewing FIGS. 2 and 3 together, the decorative part 18 has a multiplicity of fold sections 22. The fold sections 22 make it possible for the length of the corrugated bellows 14 to be changeable in the case of retraction and extension of the steering wheel 16.

As can be seen in particular in FIGS. 3 and 4, the fold sections 22 are produced in that a material property of the weft-knitted fabric 20 is changed by a thermal input of energy. The thermal input of energy may be realized by means of lasers, warm air or hot air.

As a result of the thermal input of energy, the weft-knitted fabric 20 is incipiently melted and weakened in a region or along a line. This produces a predetermined bending point 24, so that the interior part 12 in the form of a corrugated bellows 14 is foldable along the predetermined bending points 24 and the length thereof is consequently changeable.

A possible method for producing the interior part 12 will be described below on the basis of FIG. 4. In the method, firstly, the decorative part 18 formed from a flat weft-knitted fabric 20 is provided. Then, the weft-knitted fabric 20 is incipiently melted along a line by means of a laser 27 in order to produce the predetermined bending point 24.

A further embodiment of the interior part 12 will be described below, wherein the same reference signs are used for identical or functionally identical parts.

FIG. 5 shows a second embodiment of the interior part 12, which differs from the first embodiment in that the interior part 12 additionally has a carrier part 26 to which the decorative part 18 is adhesively bonded, in particular onto which the decorative part is laminated, by means of an adhesive layer 28. The carrier part 26 is a thermoplastic injection-molded part which defines the contour of the interior part 12.

The interior part 12 is distinguished by its fold sections 22 and the flexibly formed surface that is consequently achieved. This is achieved through targeted changing of the material properties of the weft-knitted fabric 20 in that the weft-knitted fabric 20 is incipiently melted along a defined line or in a defined region by means of a thermal process. In this way, the interior part 12 allows compact folding of the surface and consequently has a reduced structural-space requirement. The textile material of the decorative part 18 gives the interior part 12 an appealing appearance and also a low weight.

Other objects, advantages and novel features of the present invention will become apparent from the following detailed description of one or more preferred embodiments when considered in conjunction with the accompanying drawings.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE CHARACTERS

10 Vehicle
12 Interior part
13 Interior compartment
14 Corrugated bellows
16 Steering wheel
18 Decorative part
20 Weft-knitted fabric
22 Fold section
24 Predetermined bending point
26 Carrier part
27 Laser
28 Adhesive layer

What is claimed is:

1. An interior part for a vehicle, comprising:
a decorative part composed of a textile material that has a fold section, wherein the fold section is a portion of the textile material that has a changed material property.

2. The interior part according to claim 1, wherein the changed material property of the portion of the textile material is a result of an input of thermal energy into the textile material.

3. The interior part according to claim 1, wherein the fold section is a weakened and/or a melted portion of the textile material.

4. The interior part according to claim 1, wherein the fold section extends along a line and/or in a region.

5. The interior part according to claim 1, wherein the fold section is a predetermined bending point and/or a weakening line.

6. The interior part according to claim 1, wherein the decorative part is a 2D knit material or a 3D knit material.

7. The interior part according to claim 1, further comprising a carrier part which is partially connected to the decorative part.

8. A method for producing an interior part for a vehicle, comprising the steps of:
providing a decorative part composed of a textile material; and
producing a fold section in the decorative part by changing a material property of the textile material along a line and/or in a region by an input of thermal energy.

9. The method according to claim 8, wherein the textile material is melted and/or weakened by the input of thermal energy.

10. A vehicle, comprising:
the interior part according to claim 1 and/or the interior part produced by the method according to claim 8.
